(19) United States
(12) Patent Application Publication
(10) Pub. No.: US 2017/0314205 A1
(43) Pub. Date: Nov. 2, 2017

(54) Microorganism Control System and Method of Using the Same

(71) Applicant: Ecolab USA Inc., St. Paul, MN (US)

(72) Inventors: Wen Li Tu, Shanghai (CN); Yu-Mei Lu, Taipei (TW)

(73) Assignee: Ecolab USA Inc., St. Paul, MN (US)

(21) Appl. No.: 15/521,343

(22) PCT Filed: Oct. 26, 2015
(86) PCT No.: PCT/US2015/057298

§ 371 Date: Apr. 24, 2017

(30) Foreign Application Priority Data
Oct. 28, 2014 (CN) 201410586445.2

(51) Int. Cl. D21H 21/36; A01N 59/00; D21H 17/09; D21H 17/66

(52) U.S. Cl. CPC D21H 21/36; D21H 17/66; A01N 59/00; D21H 17/09

(57) ABSTRACT

The present invention relates to microorganism control field in process for treatment of pulp and/or water in paper-making process. More specifically, the present invention provides a microorganism control system, which comprises a first component and a second component which are separately provided, the first component comprises a stabilized halogen-containing bactericidal agent (e.g., a stabilized hypochlorite), and the second component comprises an aminosulfonic acid reagent (e.g., aminosulfonic acid). The present invention further provides a method for controlling microorganism in process for treatment of pulp and/or water in papermaking process, which comprises using the microorganism control system of the present invention.

### CROSS-REFERENCE TO RELATED APPLICATION

This application claims priority to Chinese Patent Application Serial No. 201410586445.2 filed on Oct. 28, 2014, the disclosure of which is incorporated herein by reference in its entirety.

### TECHNICAL FIELD

The present invention relates to microorganism control field in a process for treatment of pulp and/or water in papermaking process. More specifically, the present invention provides a microorganism control system, which comprises a first component and a second component that are separately provided, the first component comprises a stabilized halogen-containing bactericidal agent (e.g., a stabilized hypochlorite), and the second component comprises an aminosulfonic acid reagent (e.g., aminosulfonic acid). The present invention further provides a method for controlling microorganism in process for treatment of pulp and/or water in papermaking process, which comprises using the microorganism control system of the present invention.

### BACKGROUND ART

Halogen compounds and stabilized halogen-containing compounds are widely used for controlling microorganisms (e.g., bacteria) in process for treatment of pulp and water in papermaking process. For example, a stabilized hypochlorite had been used for controlling degradation of pulp and paper making additives, decrease of production efficiency and corrosion, etc., which are caused by growth of microorganisms in papermaking process. It had been reported that a nitrogen-containing compound (e.g., aminosulfonic acid, urea, ammonium sulfate, etc.) could be used as stabilizing agent to stabilize hypochlorite. However, such stabilized hypochlorite still has a series of problems.

For example, in acid papermaking process, the use of stabilized hypochlorite (e.g., hypochlorite stabilized with ammonium sulfate) is tremendously restricted. This is because the acid papermaking process has a relatively low pH value, and is prone to forming dichloramine and trichloramine. The dichloramine and trichloramine are not desired microbicides, because they are not stable and have high volatility and toxicity in comparison with mono-chloroamine.

In addition, previous reports indicate that the use of oxidant such as sodium hypochlorite may influence pH of paper machine system, result in fluctuation of pH, which may further influence the use efficiency of fibers and wet-end additives.

According to different pH values in papermaking process, paper machine systems can be divided into 3 types: acid system, pH usually being 4.5-6.5; neutral system, pH usually being 6.6-7.5; and basic system, pH usually being 7.5-8.5. The pH of paper machine system has great effects on dissolubility of xylon components, especially on phase transition of dissoluble substance. When pH increases, the dissolubility of xylon components would increase, which result in increase of anion interfering substances, corresponding changes of surface charges and other components on fibers, and increase of resin dissolubility. When pH decreases, indissoluble deposit is prone to forming. Thus, it is important to keep a stable pH of paper machine system for papermaking process (especially for paper machine retaining, shaping). For example, the following means can be used to regulate pH of paper machine system: using sulfuric acid, SO₂ or aluminum salt to reduce pH of the system, while using NaOH (as alkali), or more common, using CO₂ and NaOH, or Na₂CO₃ (as buffer system) to elevate pH of the system.

However, in some cycle closed system (e.g., basic papermaking process), hypochlorite and stabilized hypochlorite usually cause elevation of paper machine pH value, which may adversely influence wet-end additives, even result in dehydration or degradation of additives. For example, when pH value of paper machine system increases from natural to basic, sizing agents such as alkyl ketene dimer (AKD) and alkenyl succinic anhydride (ASA) would be dehydrated and form deposit. In addition, when pH value of the system is greater than 8, yellowing may occur in pulp making process of BCTMP (Bleached Chemical Thermo-Mechanical Pulp). Further, the increase of system pH value may also result in changes of electrons and electric charges of polymers, which may lead to adverse changes of papermaking system. For example, when basicity of papermaking system is elevated, scaling formation may occur easily.

Hence, the pH value of papermaking system, especially pH value at wet end should be controlled to avoid adverse effects caused by elevation of pH value. In fact, the inventors had tried to control system pH value by adding an acid (e.g., sulfuric acid and citric acid). However, corresponding results showed that although the addition of sulfuric acid and citric acid could avoid elevation of system pH value, it also resulted in the decrease or even lose in microbiocidal activity and biofilm-removal capacity of halogen-containing bactericides and stabilized halogen-containing bactericides (e.g., hypochlorite), leading to the consequence that microorganisms could not be effectively controlled.

Thus, an improved microorganism control system and an improved method for controlling microorganism are still in need in the art, so as to avoid increase of system pH value and effectively maintain (even enhance) microbiocidal activity and biofilm-removal capacity of bactericides in a process for treatment of pulp and water in papermaking process, for example, in a process for treatment of pulp and water using a halogen-containing bactericide (e.g., hypochlorite), and thus to fulfill effective control of microorganisms and avoid adverse effects of the increase of the system pH value.

Contents of the Invention In the present invention, unless other indicated, all scientific and technological terms used in the text have common meanings known by those skilled in the art. However, in order to better understand the present invention, the definitions and explanations of concerned terms are provided as follows. In addition, those in the present specification (including definitions) should be used in conflicting situations.

As used in the text, the term “halogen-containing bactericide” refers to an agent containing a halogen element (e.g., F, Cl, Br, I, etc.) and having microbiocidal activity. Halogen-containing bactericides are one of the disinfectors that are used for longest term, most widely, and have ideal bactericidal effects, and have merits of cheap, easy to use, and broad-spectrum bactericidal. These agents include but are not limited to oxides of halogen elements, oxygen-containing acids of halogen elements and salts or esters thereof. As well known by those skilled in the art, these reagents (e.g., oxides, oxygen-containing acids of halogen elements and salts or esters thereof) continuously release active halogen ions (e.g., fluorine ions, chlorine ions, bromine ions, and iodine ions) in water to form hypohalous acids, which have strong oxidation effect, can bind to protoplasm in body of microorganisms and result in death of microorganisms, so that these agents can be used as bactericides for killing microorganisms or controlling microorganisms. In the present invention, “halogen-containing bactericide” includes but is not limited to oxides, oxygen-containing acids of F, Cl, Br, and I and salts or esters thereof, and examples thereof can be trichloroisocyanuric acid, dichloroisocyanuric acid, sodium dichloroisocyanurate, chlorinated sodium phosphate, chloramine T, tetrachloroglycoluril, bromochloroisocyanuric acid, chlorine dioxide, hydantoin bromate, dibromohydantoin. However, specifically preferred halogen-containing bactericides are oxides, oxygen-containing acids and salts or esters thereof of Cl and Br, for example, but not being limited to, hypochlorous acid and salts thereof. More preferred, “halogen-containing bactericide” is sodium hypochlorite.

It is well known by those skilled in the art that some “halogen-containing bactericides” (e.g., hypochlorous acid) have strong oxidizability, quick action effects, and could rapidly be invalid in environment with high need of oxidation, such as in pulp or water in papermaking process. Thus, it is usually used in combination with a stabilizing agent to extend its action time and effects. Hence, as used in the text, “stabilized halogen-containing bactericide” refers to a halogen-containing bactericide stabilized with a stabilizing agent, that is, a composition or mixture comprising a stabilizing agent and a halogen-containing bactericide. The stabilizing agent for halogen-containing bactericide is well known in the art, for example, but not limited to, nitrogen-containing stabilizing agent, such as ammonium sulfate, urea, aminosulfonic acid, aminosulfonate (e.g., sodium aminosulfonate), dimethylhydrazine (DMH), other nitrogen sources, or combination thereof.

As used in the text, the term “aminosulfonic acid agent” refers to aminosulfonic acid (NH₂—SO₂—OH) and substituted aminosulfonic acid, which can be represented by formula (R₁,R₂)—N—SO₂—OH, wherein R₁ and R₂ independently represents H or hydrocarbyl substituent group. For example, the hydrocarbyl substituent group can be selected from C1-C20 alkyl (e.g., C1, C2, C3, C4, C5, C6, C7, C8, C9, C10, C11, C12 alkyl), C3-C20 cycloalkyl (e.g., C3, C4, C5, C6, C7, C8 cycloalkyl), morpholinyl, piperidyl. Aminosulfonic acid reagents are well known in the art, examples thereof including but not being limited to methylaminosulfonic acid, ethylaminosulfonic acid, propylaminosulfonic acid, butylaminosulfonic acid, pentylaminosulfonic acid, octylaminosulfonic acid, dioctylaminosulfonic acid, dodecylaminosulfonic acid, di(dodecyl)aminosulfonic acid, octadecylaminosulfonic acid, dicyclohexylaminosulfonic acid, morpholinylaminosulfonic acid, piperidylaminosulfonic acid, or any combinations thereof.

The present invention is based on at least the unexpected findings of the inventors: there is synergistic effect between a halogen-containing bactericide, especially a stabilized halogen-containing bactericide (e.g., a stabilized hypochlorite), and an aminosulfonic acid reagent (e.g., aminosulfonic acid) in a process for treatment of pulp and/or water in papermaking process. In particular, the use of aminosulfonic acid reagent not only avoids the increase of system pH value during papermaking process, but also enhances the ability of halogen-containing bactericide for controlling microorganisms (that is, maintaining microbiocidal activity of halogen-containing bactericide, and enhancing biofilm removal capacity of halogen-containing bactericide). That is, the inventors surprisingly find that aminosulfonic acid reagents have dual functions in a microorganism control process using halogen-containing bactericides: on the one hand, it has function of regulating pH, which effectively maintains pH value of microorganism control system; on the other hand, it has function of synergizing agent, which enhances the ability of a stabilized halogen-containing bactericide for controlling microorganisms (i.e., it not only maintains microbiocidal activity of halogen-containing bactericide (especially a stabilized halogen-containing bactericide, e.g., a stabilized hypochlorite), but also enhances biofilm removal capacity of halogen-containing bactericide (especially a stabilized halogen-containing bactericide, e.g., a stabilized hypochlorite)).

Therefore, in one aspect, the present invention provides a microorganism control system, which comprises a first component and a second component separated between each other, wherein the first component comprises a halogen-containing bactericide, and the second component comprises an aminosulfonic acid reagent.

In one preferable embodiment, the halogen-containing bactericide is selected from oxides, oxygen-containing acids of F, Cl, Br and I and salts or esters thereof, for example, oxides, oxygen-containing acids of Cl and Br and salts or esters thereof. In one preferable embodiment, the halogen-containing bactericide is hypohalous acid or salt thereof, for example, hypochlorous acid or salt thereof. In one preferable embodiment, the hypochlorite is a metal salt of hypochlorous acid, for example, alkali metal salt. Preferably, the hypochlorite is sodium hypochlorite.

In one preferable embodiment, the halogen-containing bactericide comprises a stabilized halogen-containing bactericide. In one preferable embodiment, the halogen-containing bactericide is a halogen-containing bactericide stabilized with a stabilizing agent. The stabilizing agent for halogen-containing bactericide is well known in the art, for example but not being limited to, nitrogen-containing stabilizing agents. Hence, in one preferable embodiment, the stabilizing agent is a nitrogen-containing stabilizing agent. Nitrogen-containing stabilizing agents useful in stabilizing halogen-containing bactericide (e.g., hypochlorite) are well known by those skilled in the art (see: for example, U.S. patent application Ser. No. 13/289,578), including but not being limited to: ammonium sulfate, urea, aminosulfonic acid, aminosulfonate (e.g., sodium aminosulfonate), dimethylhydrazine (DMH), other nitrogen sources, or combinations thereof. In one preferable embodiment, the nitrogen-containing stabilizing agent is selected from ammonium sulfate, urea and/or dimethylhydrazine (DMH). In one specifically preferable embodiment, the nitrogen-containing stabilizing agent is ammonium sulfate and/or urea. In one specifically preferable embodiment, the nitrogen-containing stabilizing agent is urea. In another specifically preferable embodiment, the nitrogen-containing stabilizing agent is ammonium sulfate. In one preferable embodiment of the present invention, the nitrogen-containing stabilizing agent is not aminosulfonic acid.

Thus, in one specifically preferable embodiment, the halogen-containing bactericide is a halogen-containing bactericide (e.g., hypohalous acid or salts thereof, e.g., hypochlorous acid or salts thereof) stabilized with ammonium sulfate, urea, aminosulfonic acid, aminosulfonate (e.g., sodium aminosulfonate). In one specifically preferable embodiment, the halogen-containing bactericide is hypohalous acid or salt thereof (e.g., hypochlorous acid or salts thereof) stabilized with a stabilizing agent. Preferably, the halogen-containing bactericide is hypochlorous acid or salt thereof, e.g., sodium hypochlorite, stabilized with ammonium sulfate or urea.

In one preferable embodiment, the aminosulfonic acid reagent is selected from aminosulfonic acid (NH₂—SO₂—OH) and/or substituted aminosulfonic acid, which can be represented with formula (R₁,R₂)—N—SO₂—OH, in which R₁ and R₂ independently represent H or hydrocarbyl substituent. For example, this hydrocarbyl substituent can be selected from, C1-C20 alkyl (e.g., C1, C2, C3, C4, C5, C6, C7, C8, C9, C10, C11, C12 alkyl), C3-C20 cycloalkyl (e.g., C3, C4, C5, C6, C7, C8 cycloalkyl), morpholinyl, piperidyl. The aminosulfonic acid reagent is well known by those skilled in the art, its examples including but not being limited to, methylaminosulfonic acid, ethylaminosulfonic acid, propylaminosulfonic acid, butylaminosulfonic acid, pentylaminosulfonic acid, octylaminosulfonic acid, dioctylaminosulfonic acid, dodecylaminosulfonic acid, di(dodecyl) aminosulfonic acid, octadecylaminosulfonic acid, dicyclohexylaminosulfonic acid, morpholinylaminosulfonic acid, piperidylaminosulfonic acid, or any combinations thereof. However, specifically preferably, the aminosulfonic acid reagent is aminosulfonic acid (NH₂—SO₂—OH).

Optionally, the second component of the microorganism control system of the present invention further comprises other components, for example, buffering agent and/or other acids, so as to further enhance its ability of controlling pH. In one preferable embodiment, the buffering agent includes but is not limited to phosphate buffering agent. In one preferable embodiment, the other acids include but are not limited to inorganic acids such as sulfuric acid, phosphoric acid, and hydrochloric acid, and organic acids such as citric acid.

Another aspect of the present invention provides a method for controlling microorganisms, comprising using the microorganism control system of the present invention.

Another aspect of the present invention provides a method for controlling microorganisms in a process for treatment of pulp and/or water, comprising:

1) providing a first component, which comprises a halogen-containing bactericide;

2) providing a second component, which comprises an aminosulfonic acid reagent;

3) applying the first component to a pulp and/or water to be treated, so as to control microorganisms therein, and using the second component to maintain the pH of the pulp and/or water to be treated.

As confirmed in the present invention, the use of the second component not only can maintain the pH of pulp and/or water to be treated, but also can enhance the microorganism controllability of the first component (microbiocidal activity and/or biofilm removal capacity).

In one preferable embodiment, the halogen-containing bactericide is selected from oxides, oxygen-containing acids of F, Cl, Br and I, and salts or esters thereof, for examples, oxides, oxygen-containing acids of Cl and Br, and salts or esters thereof. In one preferable embodiment, the halogen-containing bactericide is hypohalous acid or salt thereof, e.g., hypochlorous acid or salts thereof. In one preferable embodiment, the hypochlorite is a metal salt of hypochlorous acid, for example, alkali metal salt. Specifically preferably, the hypochlorite is sodium hypochlorite.

In one preferable embodiment, the halogen-containing bactericide comprises a stabilized halogen-containing bactericide. In one preferable embodiment, the halogen-containing bactericide is a halogen-containing bactericide stabilized with a stabilizing agent. The stabilizing agent for the halogen-containing bactericide is well known in the art, for example, but not limited to, nitrogen-containing stabilizing agent. Hence, in one preferable embodiment, the stabilizing agent is nitrogen-containing stabilizing agent. The nitrogen-containing stabilizing agent useful in stabilizing halogen-containing bactericide (e.g., hypochlorite) is well known in the art (see: for example, U.S. patent application Ser. No. 13/289,578), including but not being limited to, ammonium sulfate, urea, aminosulfonic acid, aminosulfonate (e.g., sodium aminosulfonate), dimethylhydrazine (DMH), other nitrogen sources, or combinations thereof. In one preferable embodiment, the nitrogen-containing stabilizing agent is selected from, ammonium sulfate, urea and/or dimethylhydrazine (DMH). In one preferable embodiment, the nitrogen-containing stabilizing agent is ammonium sulfate and/or urea. In one preferable embodiment, the nitrogen-containing stabilizing agent is urea. In another preferable embodiment, the nitrogen-containing stabilizing agent is ammonium sulfate. In one preferable embodiment of the present invention, the nitrogen-containing stabilizing agent is not aminosulfonic acid.

Thus, in one preferable embodiment, the halogen-containing bactericide is a halogen-containing bactericide (e.g., hypohalous acid or salts thereof, e.g., hypochlorous acid or salts thereof) stabilized with ammonium sulfate, urea, aminosulfonic acid, aminosulfonate (e.g., sodium aminosulfonate). In one preferable embodiment, the halogen-containing bactericide is a hypohalous acid or salt thereof (e.g., hypochlorous acid or salts thereof) stabilized with a stabilizing agent. Specifically preferably, the halogen-containing bactericide is hypochlorous acid or salt thereof, e.g., sodium hypochlorite, stabilized with ammonium sulfate or urea.

In one preferable embodiment, the aminosulfonic acid reagent is selected from aminosulfonic acid (NH₂—SO₂—OH) and/or substituted aminosulfonic acid, which can be represented with formula (R₁,R₂)—N—SO₂—OH, wherein R₁ and R₂ independently represent H or hydrocarbyl substituent. For example, this hydrocarbyl substituent can be selected from C1-C20 alkyl (e.g., C1, C2, C3, C4, C5, C6, C7, C8, C9, C10, C11, C12 alkyl), C3-C20 cycloalkyl (e.g., C3, C4, C5, C6, C7, C8 cycloalkyl), morpholinyl, piperidyl. The aminosulfonic acid reagent is well known by those skilled in the art, its examples include but are not limited to, methylaminosulfonic acid, ethylaminosulfonic acid, propylaminosulfonic acid, butylaminosulfonic acid, pentylaminosulfonic acid, octylaminosulfonic acid, dioctylaminosulfonic acid, dodecylaminosulfonic acid, di(dodecyl) aminosulfonic acid, octadecylaminosulfonic acid, dicyclohexylaminosulfonic acid, morpholinylaminosulfonic acid, piperidylaminosulfonic acid, or any combinations thereof. However, specifically preferably, the aminosulfonic acid reagent is aminosulfonic acid (NH₂—SO₂—OH).

Optionally, the second component further comprises other components, for example, buffering agent and/or other acids, so as to further enhance its pH controllability. In one preferable embodiment, the buffering agent includes but is not limited to phosphate buffering agent. In one preferable embodiment, the other acids include but are not limited to inorganic acids such as sulfuric acid, phosphoric acid, and hydrochloric acid, and organic acids such as citric acid.

In one preferable embodiment, the first component and the second component can be added simultaneously or in any sequence.

In one preferable embodiment, the treatment of pulp and/or water is a treatment of pulp and/or water in papermaking process, such as treatment of pulp and/or water in acid papermaking process or basic papermaking process. In one preferable embodiment, the first component and the second component can be added separately or simultaneously to any one or more of the following positions in papermaking step of papermaking process: a pulp-storing device, broke basin, recycle pulp tower, long-short fiber storing tower, starch storing tower, blend pulp basin, pulp forming basin, pulp flowing box, head box, under-net white water basin, white water tower, white water basin, turbid white water basin, clean white water basin, clarifying water basin, outlet of impact pump, multi-pan recycling basin, warm water tank, clean water basin, and/or spraying water basin. In one preferable embodiment, in process flow of papermaking process, the first component has a final concentration of 0.01 ppm to 10 ppm, for example, 0.05 ppm to 10 ppm, for example, 0.1 ppm to 10 ppm, for example, 1 ppm to 10 ppm, for example, 2.5 ppm, 5 ppm or 10 ppm, expressed in available chlorine as converted from concentration of free halogen elements or total halogen elements.

In one preferable embodiment, the second component is used to maintain the pH value of the pulp and/or water to be treated at a level of not greater than pH 10, for example, not greater than pH 9, for example, not greater than pH 8. In one preferable embodiment, the second component is used to maintain the pH value of the pulp and/or water to be treated at a level of pH 2-10, for example, pH 3-9, for example, pH 4-9, for example, pH 5-8, for example, pH 6-8.

Another aspect of the present invention relates to a use of an aminosulfonic acid reagent in regulation of pH value of a halogen-containing bactericide or a microorganism control system using a halogen-containing bactericide.

In one preferable embodiment, the halogen-containing bactericide is selected from oxides, oxygen-containing acids of F, Cl, Br and I, and salts or esters thereof, for example, oxides, oxygen-containing acids of Cl and Br, and salts or esters thereof. In one preferable embodiment, the halogen-containing bactericide is hypohalous acid or salt, e.g., hypochlorous acid or salts thereof. In one preferable embodiment, the hypochlorite is a metal salt of hypochlorous acid, for example, an alkali metal salt. Specifically preferably, the hypochlorite is sodium hypochlorite.

In one preferable embodiment, the halogen-containing bactericide comprises a stabilized halogen-containing bactericide. In one preferable embodiment, the halogen-containing bactericide is a halogen-containing bactericide stabilized with a stabilizing agent. The stabilizing agent for the halogen-containing bactericide is well known in the art, for example, but not limited to, nitrogen-containing stabilizing agent. Hence, in one preferable embodiment, the stabilizing agent is nitrogen-containing stabilizing agent. The nitrogen-containing stabilizing agent useful in stabilizing halogen-containing bactericide (e.g., hypochlorite) is well known in the art (see: for example, U.S. patent application Ser. No. 13/289,578), including but not being limited to, ammonium sulfate, urea, aminosulfonic acid, aminosulfonate (e.g., sodium aminosulfonate), dimethylhydrazine (DMH), other nitrogen sources, or combinations thereof. In one preferable embodiment, the nitrogen-containing stabilizing agent is selected from, ammonium sulfate, urea and/or dimethylhydrazine (DMH). In one preferable embodiment, the nitrogen-containing stabilizing agent is ammonium sulfate and/or urea. In one preferable embodiment, the nitrogen-containing stabilizing agent is urea. In another preferable embodiment, the nitrogen-containing stabilizing agent is ammonium sulfate. In one preferable embodiment of the present invention, the nitrogen-containing stabilizing agent is not aminosulfonic acid.

Thus, in one preferable embodiment, the halogen-containing bactericide is a halogen-containing bactericide (e.g., hypohalous acid or salts thereof, e.g., hypochlorous acid or salts thereof) stabilized with ammonium sulfate, urea, aminosulfonic acid, aminosulfonate (e.g., sodium aminosulfonate). In one preferable embodiment, the halogen-containing bactericide is a hypohalous acid or salt thereof (e.g., hypochlorous acid or salts thereof) stabilized with a stabilizing agent. Specifically preferably, the halogen-containing bactericide is hypochlorous acid or salt thereof, e.g., sodium hypochlorite, stabilized with ammonium sulfate or urea. In one preferable embodiment, the aminosulfonic acid reagent is selected from aminosulfonic acid (NH₂—SO₂—OH) and/or substituted aminosulfonic acid, which can be represented with formula (R₁,R₂)—N—SO₂—OH, wherein R₁ and R₂ independently represent H or hydrocarbyl substituent. For example, this hydrocarbyl substituent can be selected from C1-C20 alkyl (e.g., C1, C2, C3, C4, C5, C6, C7, C8, C9, C10, C11, C12 alkyl), C3-C20 cycloalkyl (e.g., C3, C4, C5, C6, C7, C8 cycloalkyl), morpholinyl, piperidyl. The aminosulfonic acid reagent is well known by those skilled in the art, its examples include but are not limited to, methylaminosulfonic acid, ethylaminosulfonic acid, propylaminosulfonic acid, butylaminosulfonic acid, pentylaminosulfonic acid, octylaminosulfonic acid, dioctylaminosulfonic acid, dodecylaminosulfonic acid, di(dodecyl) aminosulfonic acid, octadecylaminosulfonic acid, dicyclohexylaminosulfonic acid, morpholinylaminosulfonic acid, piperidylaminosulfonic acid, or any combinations thereof. However, specifically preferably, the aminosulfonic acid reagent is aminosulfonic acid (NH₂—SO₂—OH).

Another aspect of the present invention relates to a use of an aminosulfonic acid reagent and a halogen-containing bactericide in manufacture of the microorganism control system of the present invention.

In one preferable embodiment, the halogen-containing bactericide is selected from oxides, oxygen-containing acids of F, Cl, Br and I, and salts or esters thereof, for example, oxides, oxygen-containing acids of Cl and Br, and salts or esters thereof. In one preferable embodiment, the halogen-containing bactericide is a hypohalous acid or salt thereof, e.g., a hypochlorous acid or salt thereof. In one preferable embodiment, the hypochlorite is metal salt of hypochlorous acid, for example, an alkali metal salt. Specifically preferably, the hypochlorite is sodium hypochlorite.

In one preferable embodiment, the halogen-containing bactericide comprises a stabilized halogen-containing bactericide. In one preferable embodiment, the halogen-containing bactericide is a halogen-containing bactericide stabilized with a stabilizing agent. The stabilizing agent for the halogen-containing bactericide is well known in the art, for example, but not limited to, nitrogen-containing stabilizing agent. Hence, in one preferable embodiment, the stabilizing agent is nitrogen-containing stabilizing agent. The nitrogen-containing stabilizing agent useful in stabilizing halogen-containing bactericide (e.g., hypochlorite) is well known in the art (see: for example, U.S. patent application Ser. No. 13/289,578), including but not being limited to, ammonium sulfate, urea, aminosulfonic acid, aminosulfonate (e.g., sodium aminosulfonate), dimethylhydrazine (DMH), other nitrogen sources, or combinations thereof. In one preferable embodiment, the nitrogen-containing stabilizing agent is selected from, ammonium sulfate, urea and/or dimethylhydrazine (DMH). In one preferable embodiment, the nitrogen-containing stabilizing agent is ammonium sulfate and/or urea. In one preferable embodiment, the nitrogen-containing stabilizing agent is urea. In another preferable embodiment, the nitrogen-containing stabilizing agent is ammonium sulfate. In one preferable embodiment of the present invention, the nitrogen-containing stabilizing agent is not aminosulfonic acid.

Thus, in one preferable embodiment, the halogen-containing bactericide is a halogen-containing bactericide (e.g., hypohalous acid or salts thereof, e.g., hypochlorous acid or salts thereof) stabilized with ammonium sulfate, urea, aminosulfonic acid, aminosulfonate (e.g., sodium aminosulfonate). In one preferable embodiment, the halogen-containing bactericide is a hypohalous acid or salt thereof (e.g., hypochlorous acid or salts thereof) stabilized with a stabilizing agent. Specifically preferably, the halogen-containing bactericide is hypochlorous acid or salt thereof, e.g., sodium hypochlorite, stabilized with ammonium sulfate or urea.

In one preferable embodiment, the aminosulfonic acid reagent is selected from aminosulfonic acid (NH₂—SO₂—OH) and/or substituted aminosulfonic acid, which can be represented with formula (R₁,R₂)—N—SO₂—OH, wherein R₁ and R₂ independently represent H or hydrocarbyl substituent. For example, this hydrocarbyl substituent can be selected from C1-C20 alkyl (e.g., C1, C2, C3, C4, C5, C6, C7, C8, C9, C10, C11, C12 alkyl), C3-C20 cycloalkyl (e.g., C3, C4, C5, C6, C7, C8 cycloalkyl), morpholinyl, piperidyl. The aminosulfonic acid reagent is well known by those skilled in the art, its examples include but are not limited to, methylaminosulfonic acid, ethylaminosulfonic acid, propylaminosulfonic acid, butylaminosulfonic acid, pentylaminosulfonic acid, octylaminosulfonic acid, dioctylaminosulfonic acid, dodecylaminosulfonic acid, di(dodecyl) aminosulfonic acid, octadecylaminosulfonic acid, dicyclohexylaminosulfonic acid, morpholinylaminosulfonic acid, piperidylaminosulfonic acid, or any combinations thereof. However, specifically preferably, the aminosulfonic acid reagent is aminosulfonic acid (NH₂—SO₂—OH).

### Beneficial Effects of the Invention

The ability of halogen-containing bactericide for controlling microorganism is usually determined by the following two aspects: i.e., microbiocidal activity (i.e., inhibiting growth of microorganisms) and biofilm removal capacity (i.e., inhibiting microorganisms to form biofilm).

The inventors surprisingly find that in the process for treatment of pulp and water in papermaking process, a halogen-containing bactericide, especially a stabilized halogen-containing bactericide (for example, a stabilized hypochlorite) and an aminosulfonic acid reagent (for example, aminosulfonic acid) show synergistic effects. Specifically, the use of aminosulfonic acid reagent not only avoids the increase of system pH value in process for treatment of pulp and/or water, reduces and eliminates the generation of some side-products at low pH environment, but also enhances the ability of a stabilized halogen-containing bactericide for controlling microorganism (i.e., maintaining microbiocidal activity of the halogen-containing bactericide, and enhancing biofilm removal capacity of the halogen-containing bactericide).

Thus, in comparison with the prior art, the microorganism control system and the method for controlling microorganisms of the present invention have the following beneficial effects:

(1) The system and method of the present invention can avoid system pH fluctuation (for example, increase of pH) caused by adding a halogen-containing bactericide, especially a stabilized halogen-containing bactericide (for example, a stabilized hypochlorite), so as to eliminate various adverse effects of pH value fluctuation;

(2) The present invention would not cause the generation of side-products and the fluctuation of pH when a halogen-containing bactericide (especially, a stabilized halogen-containing bactericide) is used in an acidic system; and

(3) The system and method of the present invention enhance the ability for controlling microorganism of a halogen-containing bactericide, especially a stabilized halogen-containing bactericide (for example, a stabilized hypochlorite) (i.e., maintaining microbiocidal activity of the halogen-containing bactericide, and enhancing biofilm removal capacity of the halogen-containing bactericide).

The embodiments of the present invention would be illustrated in combination with the figures and examples as follows. However, those skilled in the art would understand that the following figures and examples are merely used to illustrate the present invention, rather than restricting the scope of the present invention. According to the following detailed description of figures and examples, the various objectives and advantage aspects of the present invention would be apparent for those skilled in the art.

### BRIEF DESCRIPTION OF DRAWINGS

FIG. 1 shows the active component (monochloroamine) as contained in a halogen-containing bactericide (sodium hypochlorite), which was stabilized with ammonium sulfate, under different pH conditions, when sulfuric acid was used to regulate pH. The halogen-containing bactericide sodium hypochlorite stabilized with ammonium sulfate under different pH conditions (pH=9.08, 5.35 or 2.15, sulfuric acid was used for pH regulation) was subjected to all wavelength scanning with an ultraviolet spectrophotometer. The results showed that when pH=9.08, the sodium hypochlorite stabilized with ammonium sulfate had characteristically highest peak at 245 nm, which indicated that the desired active component, i.e., monochloroamine (having characteristic wavelength of 245 nm) was comprised therein. When pH=5.35 or 2.15, the sodium hypochlorite stabilized with ammonium sulfate had highest peaks at 206 nm or 295 nm (rather than 245 nm), respectively, which indicated that the undesired side product, i.e., dichloroamine, was generated, while the amount of the desired monochloroamine decreased significantly. These results showed that when sulfuric acid was used as pH regulating agent to down-regulate pH, the active component (monochloroamine) in a halogen-containing bactericide stabilized with ammonium sulfate would decrease significantly, and undesired side products would be generated, and stability of the product would decrease significantly.

FIG. 2 shows the active component (monochloroamine) as contained in a halogen-containing bactericide (sodium hypochlorite), which was stabilized with ammonium sulfate, under different pH conditions, when aminosulfonic acid was used to regulate pH. The halogen-containing bactericide sodium hypochlorite stabilized with ammonium sulfate under different pH conditions (pH=9.08, 4.68 or 2.72, aminosulfonic acid was used for pH regulation) was subjected to all wavelength scanning with an ultraviolet spectrophotometer. The results showed that, under all 3 pH conditions, the halogen-containing bactericide stabilized with ammonium sulfate had highest peak at 245 nm or nearby, and did not show peaks at 206 nm and 295 nm. These results showed that when aminosulfonic acid was used as pH regulating agent to down-regulate pH, the halogen-containing bactericide stabilized with ammonium sulfate would substantively remain stable, and the amount of active component (monochloroamine) therein did not change significantly, and undesired side products (for example, dichloroamine) would not be generated.

FIG. 3 shows the microorganism controllability (microbiocidal activity and biofilm removal capacity) of a halogen-containing bactericide (having concentrations of 2.5 ppm, 5 ppm and 10 ppm, respectively) stabilized with ammonium sulfate, under conditions of using or not using aminosulfonic acid to regulate pH, which was measured by total aerobic bacteria counting (TABC, cfu/ml), ATP fluorescence method (RLU) and spectrophotometric method (absorbance at 480 nm), in which sodium hypochlorite samples of 2.5 ppm, 5 ppm and 10 ppm were used as bactericide controls. The results showed that in presence of aminosulfonic acid, the halogen-containing bactericide stabilized with ammonium sulfate had a significantly enhanced biofilm removal capacity, as compared to the situation in absence of aminosulfonic acid. These results showed that in a microorganism control system using halogen-containing bactericide, aminosulfonic acid not only had function of regulating pH (i.e., avoiding pH value fluctuation, for example, being elevated), but also had synergistic effect on biofilm removal capacity of the halogen-containing bactericide.

### SPECIFIC MODELS FOR CARRYING OUT THE INVENTION

The following examples are intended to illustrate the present invention (rather than to restrict the present invention). However, the scope of the present invention is not limited to the following examples. Those skilled in the art would understand that the present invention could be changed and modified in varioius ways without departing from the sprit and scope of the present invention.

The materials and test methods used in the examples are generally and/or specifically described in the present invention. Although many materials and operation methods used for fulfilling the objectives of the present invention are well known in the art, they are still described in details as much as possible. The chemicals of which sources are not explicitly described are all readily producible by those skilled in the art or commercially available.

### Example 1

The present example demonstrated that: when a stabilized halogen-containing bactericide was added to a pulp (for example, broke pulp and white water pulp), the pH value of pulp would increase; and when sulfuric acid or citric acid was used to regulate pH value of halogen-containing bactericide, halogen-containing bactericide would become unstable, in which available chlorine content would decrease significantly. However, when aminosulfonic acid was used to regulate pH value of halogen-containing bactericide, the fluctuation of pH value of halogen-containing bactericide and pulp would be effectively avoided, and the halogen-containing bactericide would remain stable, in which available chlorine content would not change significantly (i.e., not decrease significantly), and thus the bactericidal effects of halogen-containing bactericide is effectively maintained.

White water samples and broke samples were taken from a paper plant, 5 parts for each, 100 ml per part, and their pH values were measured (for white water samples, pH was 8.20; for broke samples, pH was 8.23). Sodium hypochlorite stabilized with urea was prepared and used as halogen-containing bactericide 1, in which the molar ratio of available chlorine in sodium hypochlorite to urea was 1:1; sodium hypochlorite stabilized with ammonium sulfate was prepared and used as halogen-containing bactericide 2, in which the molar ratio of available chlorine in sodium hypochlorite to ammonium sulfate was 1:1. The available chlorine content of sodium hypochlorite used in the example was 12.5%. The stabilized halogen-containing bactericide 1 (pH was 12.15, dosage was 1.25 ppm or 5 ppm, expressed in Cl₂) and the stabilized halogen-containing bactericide 2 (pH was 10.0, dosage was 1.25 ppm or 5 ppm, expressed in Cl₂) in different amounts were separately added to the white water samples and broke samples, and the pH values of the resultant mixtures were measured. The results are shown in Table 1.

TABLE 1
Effects of the addition of stabilized
halogen-containing bactericides on
pH values of different pulps of paper machine system

| | Dosage | pH | pH of |
|---|---|---|---|
| Bactericide | expressed | of broke | white water |
| as added | in Cl₂ | sample | sample |
| Blank (not adding any | 0 | 8.23 | 8.20 |
| bactericide) | | | |
| Halogen-containing | 1.25 | 8.45 | 8.48 |
| bactericide 1 | 5 | 8.87 | 8.84 |
| pH was 12.15 | | | |
| Halogen-containing | 1.25 | 8.30 | 8.24 |
| bactericide 2 | 5 | 8.38 | 8.31 |
| pH was 10.0 | | | |

The results showed that when the stabilized halogen-containing bactericides were added to white water samples and broke samples, the pH values of pulps all increased, in which when the amount of urea-stabilized sodium hypochlorite was 5 ppm (expressed in Cl₂), pH value increased from 8.23 to 8.87 (the highest) for the broke samples, and increased from 8.20 to 8.84 (the highest) for the white water samples. Thus, the addition of the halogen-containing bactericide resulted in an increase of pulp pH value.

In order to avoid fluctuation of pulp pH value (for example, avoiding an increase of pulp pH value), the pH of halogen-containing bactericide could be regulated so that it was similar to the pH value of paper machine system (i.e., pulp) before the halogen-containing bactericide was added to pulp.

In this connection, firstly, a urea-stabilized sodium hypochlorite was prepared in proportion that the molar ratio of available chlorine to urea was 1:1, and the sodium hypochlorite had available chlorine content of 12.5%. Then, 5 beakers were provided and separately added with 1 ml of the prepared urea-stabilized halogen-containing bactericide. After that, 29 ml of water was added to the first beaker for dilution (blank control), while the other 4 beakers were separately added with 20% sulfuric acid (0.5 ml or 1.0 ml) or 20% citric acid (1.0 ml or 2.0 ml), and added with water to reach a final volume of 30 ml. Finally, pH values and available chlorine contents (ppm) of solutions in the 5 beakers were measured. The results are shown in Table 2.

TABLE 2
Effects of addition of sulfuric acid
or citric acid on urea-stabilized
halogen-containing bactericide

| | Acid | | Available |
|---|---|---|---|
| | volume as | Solution | chlorine, |
| Acid as used | added (ml) | pH | ppm |
| Blank control | 0 | 12.75 | 2550 |
| 20% sulfuric acid | 0.5 | 7.35 | 750 |
| | 1.0 | 2.15 | 455 |
| 20% citric acid | 1.0 | 7.75 | 1250 |
| | 2.0 | 3.65 | 725 |

The results showed that when an acid (for example, sulfuric acid or citric acid) was added to the urea-stabilized halogen-containing bactericide, its pH value was effectively regulated (i.e., significantly decreased). However, in comparison with the blank control (not adding acid to regulate pH), the addition of sulfuric or citric acid also resulted in a significant decrease of available chlorine in the solution. This indicated that the addition of sulfuric acid or citric acid would result in that a stabilized halogen-containing bactericide became unstable, effective component degraded, and available chlorine content decreased significantly.

Further, 10% aminosulfonic acid (which was used to replace sulfuric acid or citric acid, which dosage was 1.1 ml or 1.24 ml) was used to repeat the above experiments. In particular, a urea-stabilized sodium hypochlorite was prepared in proportion that the molar ratio of available chlorine in sodium hypochlorite to urea was 1:1, and the sodium hypochlorite had an available chlorine content of 8.5%. In addition, after aminosulfonic acid was added, pH values and available chlorine contents (ppm) in solutions were measured, and after standing for 40 min, 120 min, and 240 min, available chlorine contents (ppm) of solutions were measured again. The results are shown in Table 3.

TABLE 3
Effects of the addition of aminosulfonic acid on urea-stabilized halogen-containing bactericide

| | Acid | Solution | | | | |
|---|---|---|---|---|---|---|
| | volume as | pH | | | | |
| | added | after | Available chlorine after mixing, ppm | | | |
| Acid as used | (ml) | mixing | 0 min | 40 min | 120 min | 240 min |
| Blank control | 0 | 12.25 | 1425 | 1325 | 1375 | 1350 |
| Aminosulfonic | 1.1 | 8.46 | 1275 | 1275 | 1325 | 1400 |
| acid | 1.24 | 5.96 | 1300 | 1325 | 1475 | 1250 |

The results showed that in comparison with the blank control (not adding with acid to regulate pH), when the stabilized halogen-containing bactericide was added with aminosulfonic acid, its pH value was effectively regulated (i.e., significantly decreased), and its available chlorine content did not change significantly (even after standing for 240 min). This indicated that aminosulfonic acid could regulated pH of halogen-containing bactericide, would not render halogen-containing bactericide unstable, and could maintain available chlorine content of solution for a long time (at least 240 min). Thus, aminosulfonic acid used as pH regulating agent had effects superior to that of sulfuric acid or citric acid.

In order to further evaluate effects of aminosulfonic acid on a stabilized halogen-containing bactericide, we further analyzed the microbiocidal activity of halogen-containing bactericide after using aminosulfonic acid to regulate pH, and after pH regulation and standing for 40 min. In brief, as stated above, to 1 ml of urea-stabilized sodium hypochlorite (having available chlorine content of 8.5%), 0, 0.8, 1.1, 1.24, 1.3 or 1.55 ml of 10% aminosulfonic acid (for regulating pH) was separately added, then water was added until the final volume was 30 ml, and pH values of solutions after adding aminosulfonic acid were measured. Pulp was taken from a paper plant, which was divided in several parts, 100 ml for each part; to each part, the prepared bactericides of different pH values which were stabilized with urea, wherein pH were regulated with aminosulfonic acid, were added, so that the pulp samples had final available chlorine concentration of 5 ppm. The pulp samples without adding any halogen-containing bactericide were used as blank control. Then, all pulp samples were incubated in 37° C. thermostat for 2 h, and then were measured for the pulp pH, and for the microorganism activity in pulp by ATP activity (RLU) and total aerobic bacteria counting (TABC, cfu/ml), so as to determine the control effect of the stabilized halogen-containing bactericide (standing for 40 min, or without standing) which pH was regulated with aminosulfonic acid on microorganism activity. The results are shown in Tables 4-5.

TABLE 4
Bactericidal effects of stabilized halogen-containing bactericide
(without standing) with pH regulated by aminosulfonic acid

| | Volume | pH of | | | |
|---|---|---|---|---|---|
| | of | bactericide | | | |
| | acid as | after | | | |
| | used | addition | ATP, | TABC, | Pulp |
| | (ml) | of acid | RLU | cfu/ml | pH |
| Blank control | / | / | 4.85E+04 | 2.50E+07 | 7.95 |
| Stabilized | 0 | 12.25 | 3.21E+03 | 4.60E+05 | 8.43 |
| halogen-containing | 0.8 | 10.19 | 1.96E+04 | 4.80E+06 | 7.98 |
| bactericide with | 1.1 | 8.46 | 6.25E+03 | 5.60E+05 | 7.96 |
| pH regulated by | 1.24 | 5.96 | 3.68E+03 | 2.60E+05 | 7.94 |
| aminosulfonic acid | 1.3 | 3.95 | 3.22E+03 | 3.00E+05 | 7.92 |
| | 1.55 | 2.61 | 4.83E+03 | 7.30E+05 | 7.90 |

TABLE 5
Bactericidal effects of stabilized halogen-containing bactericide
(standing for 40 min) with pH regulated by aminosulfonic acid

| | | pH of | | | |
|---|---|---|---|---|---|
| | Volume of | bactericide | | | |
| | acid as | after | | | |
| | used | addition of | ATP, | TABC, | Pulp |
| | (ml) | acid | RLU | cfu/ml | pH |
| Blank control | / | / | 7.19E+04 | 2.50E+07 | 7.95 |
| Stabilized | 0 | 12.25 | 3.41E+03 | 1.34E+05 | 8.48 |
| halogen-containing | 0.8 | 10.19 | 2.50E+04 | 4.90E+05 | 8.05 |
| bactericide with | 1.1 | 8.46 | 8.71E+03 | 2.80E+05 | 7.99 |
| pH regulated by | 1.24 | 5.96 | 3.32E+03 | 3.20E+05 | 7.97 |
| aminosulfonic acid | 1.3 | 3.95 | 5.19E+03 | 2.42E+05 | 7.97 |
| | 1.55 | 2.61 | 5.32E+03 | 1.95E+05 | 7.96 |

The results showed that in comparison with blank control, both the urea-stabilized halogen-containing bactericide without being regulated with acid and the stabilized halogen-containing bactericide with pH regulated by aminosulfonic acid had bactericidal effects in pulp, and they could reduce total aerobic bacteria number (TABC, cfu/ml) by about 2 log. At the same time, in comparison with the stabilized halogen-containing bactericide without being regulated with acid, the use of the stabilized halogen-containing bactericide with pH regulated by aminosulfonic acid did not result in significant increase of pulp pH. These results showed that aminosulfonic acid not only avoided pH fluctuation (i.e., increase) of halogen-containing bactericide and pulp, but also effectively remained bactericidal effects (i.e., capability of inhibiting growth of bacteria) of halogen-containing bactericide.

### Example 2

The present example demonstrated that: when sulfuric acid was used to regulate pH value of ammonium sulfate-stabilized halogen-containing bactericide (sodium hypochlorite), halogen-containing bactericide would become unstable, in which active component (monochloroamine) content decreased significantly, and undesired side products, for example, dichloroamine, were generated. However, when aminosulfonic acid was used to regulate pH value of ammonium sulfate-stabilized halogen-containing bactericide, the halogen-containing bactericide remained stable, in which active component (monochloroamine) content did not change significantly, and undesired side products, for example, dichloroamine, were not generated.

As stated above, an ammonium sulfate-stabilized sodium hypochlorite was prepared in proportion that the molar ratio of available chlorine in sodium hypochlorite to ammonium sulfate was 1:1, and the used sodium hypochlorite had available chlorine content of 12.5%. To 3 beakers, 1 ml of the prepared halogen-containing bactericide was added separately, then 29 ml of water was added to one of the beakers for dilution (solution pH was measured as 9.08); the other 2 beakers were regulated with sulfuric acid to reach pH of 5.35 and 2.15, respectively, and their volume was adjusted with water to reach 30 ml. After measurement, the 3 solutions had available chlorine content of 2550 ppm, 750 ppm and 455 ppm, respectively.

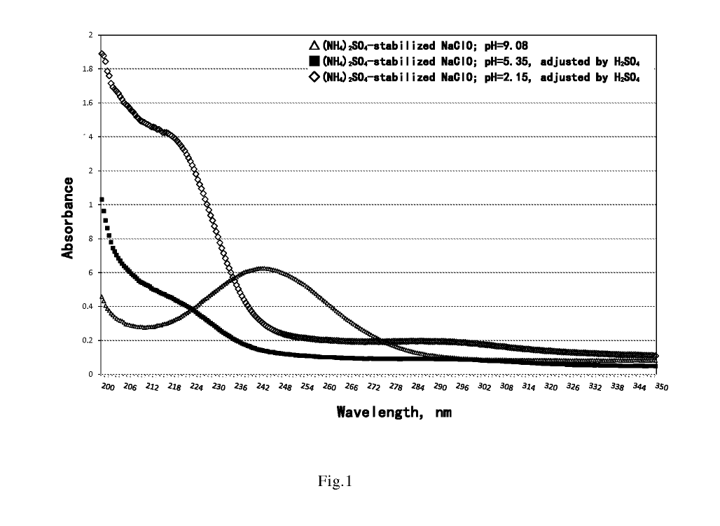

The 3 solutions were subjected to all wavelength scanning with an ultraviolet spectrophotometer. The results were shown in FIG. 1. The results of FIG. 1 showed that when pH=9.08, the ammonium sulfate-stabilized halogen-containing bactericide, sodium hypochlorite, had characteristically highest peak at 245 nm, which indicated that the desired active component, i.e., monochloroamine (having characteristic wavelength of 245 nm) was comprised therein. When pH=5.35 or 2.15, the ammonium sulfate-stabilized halogen-containing bactericide had highest peaks at 206 nm or 295 nm (rather than 245 nm), respectively, which indicated that the undesired side product, i.e., dichloroamine, was generated, while the amount of the desired monochloroamine decreased significantly. These results show that when sulfuric acid is used as pH regulating agent to regulate pH, the active component (monochloroamine) in a halogen-containing bactericide stabilized with ammonium sulfate would decrease significantly, and undesired side products would be generated, and stability of the product would decrease significantly.

As stated above, an ammonium sulfate-stabilized halogen-containing bactericide was prepared. To 3 beakers, 1 ml of the prepared halogen-containing bactericide was added, respectively, then 29 ml of water was added to one of the beakers for dilution (solution pH was measured as 9.08); the other 2 beakers were regulated with aminosulfonic acid to reach pH of 4.68 and 2.72, respectively, and their volume was adjusted with water to reach 30 ml. After measurement, the 3 solutions had available chlorine content of 2550 ppm, 2315 ppm and 2195 ppm, respectively.

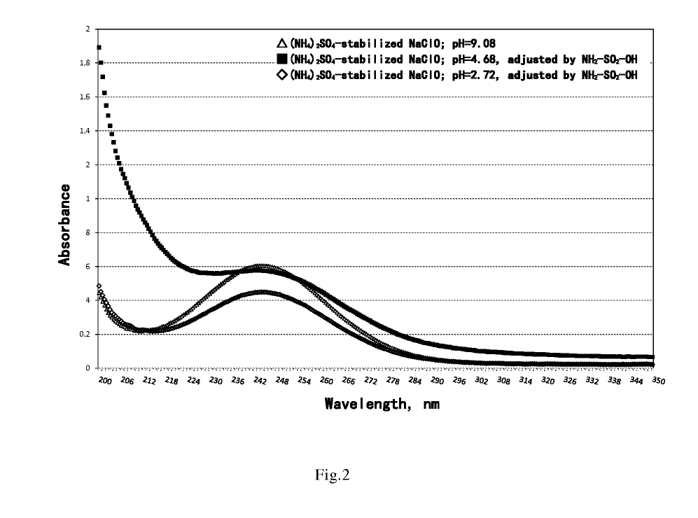

The 3 solutions were subjected to all wavelength scanning with an ultraviolet spectrophotometer. The results were shown in FIG. 2. The results of FIG. 2 showed that under 3 pH conditions, the ammonium sulfate-stabilized halogen-containing bactericide always had the highest peak (i.e., containing active component monochloroamine) at 245 nm or nearby, and did not show peaks at 206 nm and 295 nm (i.e., not generating side product dichloroamine). These results show that when aminosulfonic acid was used as pH regulating agent to regulate pH, the halogen-containing bactericide stabilized with ammonium sulfate would substantively remain stable, and the amount of active component (monochloroamine) therein did not change significantly, and undesired side products (for example, dichloroamine) would not be generated. Thus, when aminosulfonic acid was used as a pH regulating agent, it could regulate pH of halogen-containing bactericide, and did not render the halogen-containing bactericide unstable (i.e., not resulting in a significant decrease of active component monochloroamine, and avoiding generation of undesired side product, for example, dichloroamine), which effects were significantly superior to those of other acids, for example, sulfuric acid.

### Example 3

The present example demonstrated that: when aminosulfonic acid was used to regulate pH value of halogen-containing bactericide, the biofilm removal capability of halogen-containing bactericide was enhanced, i.e., aminosulfonic acid had synergistic effect on biofilm removal capacity of the stabilized halogen-containing bactericide.

White water was taken in acid papermaking process in a paper plant, filtrated, and measured for its pH (its pH was 5.10). The filtrated white water sample was added with casein broth culture medium, and loaded on a 24-well plate, then subjected to shaking culture for 48 h at 37° C. and 150 rpm, until biofilm was formed. After that, the biofilm was washed gently with phosphate buffer solution, and moved out for standby use.

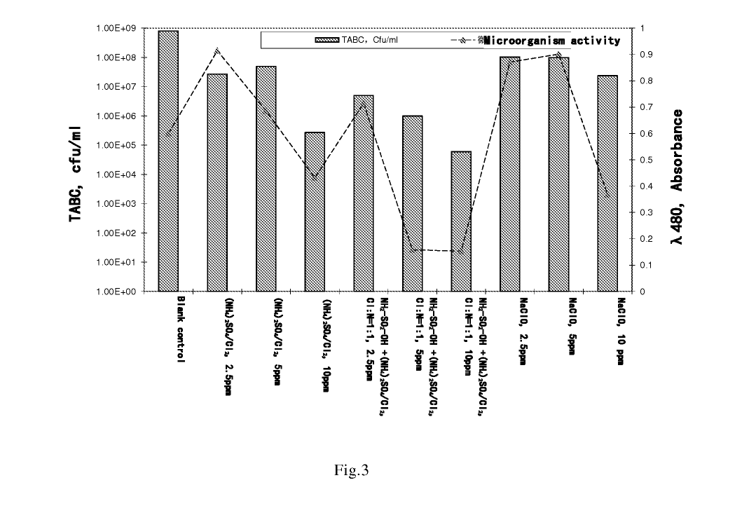

As stated in Example 2, an ammonium sulfate-stabilized halogen-containing bactericide sodium hypochlorite was prepared. The prepared ammonium sulfate-stabilized halogen-containing bactericide was divided into 2 parts, one part was added with aminosulfonic acid to regulate pH as 5.12, while the other part was not subjected to pH regulation (i.e., not adding aminosulfonic acid, which pH was 9.08). The 2 halogen-containing bactericides were separately added to white water, at a dosage of 2.5 ppm, 5 ppm or 10 ppm (expressed in available chlorine), respectively. In addition, sodium hypochlorite was used as bactericide control and added to white water, at a dosage of 2.5 ppm, 5 ppm and 10 ppm (expressed in available chlorine). Then, the white water samples added with bactericides (i.e., aminosulfonic acid-containing ammonium sulfate-stabilized halogen-containing bactericide, aminosulfonic acid-free ammonium sulfate-stabilized halogen-containing bactericide, or sodium hypochlorite) were separately added to the above 24-well plate with formed biofilm, and subjected to shaking for 12 h at 37° C. and 150 rpm. Then, white water was removed, without damaging the biofilm, and the 24-well plate was washed with phosphate buffering solution. Then, the 24-well plate was added with biological dye, iodonitrotetrazolium chloride, and absorbance at 480 nm was read. The absorbance was in positive correlation with microorganism activity. The lower the absorbance, the lower the microorganism activity, the higher the inhibition effect on microorganism, and the more potent the biofilm removal capability of the bactericide was. In addition, the ATP activity (RLU) and total aerobic bacteria count (TABC, cfu/ml) in white water as removed were measured as well, to determine microorganism activity in white water. The results are shown in FIG. 3. The results of FIG. 3 showed that as compared to the situation in absence of aminosulfonic acid, in presence of aminosulfonic acid, the ammonium sulfate-stabilized halogen-containing bactericide had a significantly enhanced biofilm removal capacity. These results indicated that in a microorganism control system using halogen-containing bactericide, aminosulfonic acid not only has function of regulating pH (i.e., avoiding pH value fluctuation, for example, increase), but also has synergistic effect on biofilm removal capacity of halogen-containing bactericide.

Although the specific models for carrying out the invention are described in details, those skilled in the art would understand that the details could be modified and changed according to the above teachings, and all these modifications and changes fall in the protection scope of the present invention. The whole scope of the present invention is given by the appended claims and any equivalents thereof.

1. A microorganism control system comprising a first component and a second component which are separated, wherein the first component comprises a halogen-containing bactericide, and the second component comprises an aminosulfonic acid reagent.

2. The microorganism control system of claim 1, wherein the halogen-containing bactericide is selected from an oxide, an oxygen-containing acid of fluorine, chlorine, bromine, or iodine, and salts or esters thereof.

3. The microorganism control system of claim 2, wherein the halogen-containing bactericide is a hypohalous acid or salt thereof.

4. The microorganism control system of claim 1, wherein the aminosulfonic acid reagent is selected from aminosulfonic acid (NH₂—SO₂—OH) and/or substituted aminosulfonic acid.

5. The microorganism control system of claim 4, wherein the aminosulfonic acid reagent is aminosulfonic acid (NH₂—SO₂—OH).

6. A method of controlling microorganism in process of treatment of pulp and/or water of a pulp and/or papermaking system comprising:
applying a halogen-containing bactericide to a pulp and/or water to control microorganisms therein, and applying an aminosulfonic acid reagent to maintain pH of the pulp and/or water to be treated.

7. The method of claim 6, wherein the halogen-containing bactericide is selected from an oxide, an oxygen-containing acid of fluorine, chlorine, bromine, or iodine, and salts or esters thereof.

8. The method of claim 7, wherein the halogen-containing bactericide is a hypohalous acid or salt thereof.

9. The method of claim 6, wherein the aminosulfonic acid reagent is selected from aminosulfonic acid (NH₂—SO₂—OH) and/or substituted aminosulfonic acid.

10. The method of claim 9, wherein the aminosulfonic acid reagent is aminosulfonic acid (NH₂—SO₂—OH).

11. (canceled)

12. The microorganism control system of claim 1, wherein the halogen-containing bactericide is stabilized with a stabilizing agent.

13. The method of claim 6, wherein the halogen-containing bactericide is stabilized with a stabilizing agent.

14. The microorganism control system of claim 12, wherein
the stabilizing agent is a nitrogen-containing stabilizing agent.

15. The method of claim 13, wherein the stabilizing agent is a nitrogen-containing stabilizing agent.

16. The microorganism control system of claim 14, wherein the nitrogen-containing stabilizing agent is selected from ammonium sulfate, urea, aminosulfonic acid, an aminosulfonate salt, dimethylhydrazine, or a combination thereof.

17. The method of claim 15, wherein the nitrogen-containing stabilizing agent is selected from ammonium sulfate, urea, aminosulfonic acid, an aminosulfonate salt, dimethylhydrazine, or a combination thereof.

18. The microorganism control system of claim 16, wherein
the stabilizing agent is ammonium sulfate, urea and/or dimethylhydrazine.

19. The method of claim 17, wherein the stabilizing agent is ammonium sulfate, urea and/or dimethylhydrazine.

20. The microorganism control system of claim 18, wherein the stabilizing agent is ammonium sulfate and/or urea.

21. The method of claim 19, wherein the stabilizing agent is ammonium sulfate and/or urea.
